(19) United States
(12) Patent Application Publication
(10) Pub. No.: US 2025/0359690 A1
(43) Pub. Date: Nov. 27, 2025

(54) HEATED QUILT

(71) Applicant: Shaoxing Lanchen Health Technology Co., Ltd, Shaoxing (CN)

(72) Inventors: Haigen Zhang, Shaoxing County (CN); Fang Yao, Yuyao City (CN); Demao Xu, Yingtan City (CN)

(21) Appl. No.: 18/734,457

(22) Filed: Jun. 5, 2024

(30) Foreign Application Priority Data
May 23, 2024 (CN) 202421137846.5

(51) Int. Cl. A47G 9/02; H05B 3/34

(52) U.S. Cl. CPC A47G 9/0215; H05B 3/342; H05B 2203/005

(57) ABSTRACT

Disclosed are a heated quilt including a first warming layer, a second warming layer and a heated layer sandwiched between the first warming layer and the second warming layer, the heated layer being provided with a heat core; the heated layer and the first warming layer or the heated layer and the second warming layer being secured by a number of fixing structures, the fixing structures being evenly distributed between the heated layer and the first warming layer or the heated layer and the second warming layer. An upper and lower warming layer in the quilt can provide good insulation for the heat generated by the heated layer, and can provide better warming effect for the user.

### CROSS-REFERENCE TO RELATED APPLICATIONS

This present application claims priority to Chinese Patent Application No. 202421137846.5, filed on May 23, 2024, the content of which is incorporated herein by reference in its entirety.

### TECHNICAL FIELD

The present disclosure relates to the technical field of bedding, and specifically to a heated quilt.

### BACKGROUND

Electric heating devices for beds can increase the temperature of the comforter during cold winter months and remove moisture and mites from the bedding, improving the comfort of people's lives. The most common type of electric heating device for bed is an electric blanket, which is plugged to enable the heating element inside the blanket for the user.

For example, CN213638254U discloses an electric blanket with a shoulder heating member, a back heating member, a hip heating member, and a foot heating member, which distributes the heating area according to the body parts, and is capable of carrying out targeted heating, and CN218784363U, CN216602349U, and CN209676516U disclose electric blankets with different improved functions.

Although the electric blanket provides convenience for people in winter, the electric blanket has a thin structure and a weak heat preservation and storage function, so it cannot meet the warmth requirement when used alone, and is usually only used to assist the quilt to increase the warmth. In addition, electric blankets have a high heating temperature, and there is a certain safety risk when using them. Therefore, there is a lack of a bed warming device with strong heat preservation performance and higher safety.

### SUMMARY

A heated quilt is provided, including:
a first warming layer, a second warming layer and a heated layer sandwiched between the first warming layer and the second warming layer, the heated layer being provided with a heating core;
the heated layer and the first warming layer or the heated layer and the second warming layer are secured by a number of fixing structures, the fixing structures being evenly distributed between the heated layer and the first warming layer or the heated layer and the second warming layer.

Further, the heating switch of the heated layer is connected to a mobile terminal of a user, the mobile terminal being capable of controlling the opening or closing of the heating switch.

Further, the heating core of the heated layer is threaded inside the heating core pipe.

Further, the heating core pipe is a double-layer structure, or the heating core pipe is made of a single layer of ribbed fabric.

Further, the heating core pipe is made of double layer hydroentangled non-woven fabric.

Further, the first warming layer including, from top to bottom, a first face fabric layer, a first warmth-retaining material filling layer and a first lining fabric layer; and/or
the second warming layer including from top to bottom a second face fabric layer, a second warmth-retaining material filling layer and a second lining fabric layer.

Further, the amount of warmth-retaining material of the first warmth filling layer is greater than the amount of warmth-retaining material of the second warmth-retaining material filling layer.

Further, the first warmth-retaining material filling layer is filled with polyester blend cotton or polyester cotton, and the second warmth filler layer is filled with glue-free cotton.

Further, the heated layer is set up to be heated independently in left and right zones, and/or the heated layer is set up to be independently heated in the head and foot zones.

Further, the heated quilt is provided with counterweights along its perimeter.

The beneficial effects obtained by the present disclosure are as follows:
1. As the heated layer is set between the two warming layers, a “sandwich structure” heated quilt is obtained, which utilizes the heatedlayer in the middle of the electric heatedquilt to generate heat, and the upper and lower warming layers in the quilt structure can provide good thermal insulation and heat storage for the heat generated by the heatedlayer, so as to let the heat form a ring-shaped heatedenvironment inside the quilt, and make the heatedeffect more durable, and provide better warming effect for the user. The effect is more durable and can provide users with better warming effect.
2. With better insulation properties, the heated quilt achieves the desired warmth at lower heating temperatures, reducing heating temperatures and increasing safety.
3. The heated layer is evenly fixed with one of the warming layers, which prevents the heating core inside the quilt from safety risks due to folding, further increasing safety compared to traditional electric blankets.
4. The uniform fixation of the heated layer with one of the warming layers also increases the fit between the heated layer and the first warming layer or the second warming layer, so that the two are less likely to separate, thereby further increasing the comfort during use.
5. The heated layer is set up as independent heating for left and right zones and/or independent heating for head and foot zones, so that the user can choose the area that needs to be heated, making the heated quilt more energy-efficient and more flexible in use.
6. The setting of counterweight around the heated comforter helps to increase the pressure borne by the body surface, relaxes the nervous system, acts as a stress reliever and improves the quality of sleep. In addition, the setting of the counterweight also prevents the heated quilt from leaking air, which further ensures the heat preservation of the heated quilt, and the warmth preservation performance is superior to that of the ordinary quilt even when it is not heated.

### BRIEF DESCRIPTION OF THE DRAWINGS

In order to more clearly illustrate the technical solutions of the embodiments of the present disclosure, the accompanying drawings required to be used in the embodiments are briefly described below, it should be understood that the following drawings show certain embodiments of the present disclosure, and therefore should not be regarded as limiting the scope, and for those skilled in the art, other related drawings may be obtained according to these drawings without creative work.

FIG. 1 is a three-dimensional schematic diagram of a heated quilt.

FIG. 2 is a schematic diagram of a filler layer of a warmth-retaining material.

FIG. 3 is a schematic diagram of a heated layer.

FIG. 4 is a schematic diagram of the overall interlayer structure of a heated quilt.

FIG. 5 is a schematic diagram of the inter-layer structure of a first warming layer.

FIG. 6 is a schematic diagram of the interlayer structure of a second warming layer.

FIG. 7 is a schematic diagram of the structure of a heating core pipe.

### DETAILED DESCRIPTION OF THE EMBODIMENTS

In order to make the objectives, technical solutions and advantages of the embodiments clearer, the technical solutions in the embodiments will be clearly and completely described below with reference to the accompanying drawings in the embodiments. Obviously, the described embodiments are part of the embodiments, not all embodiments. All other embodiments obtained by those skilled in the art without creative efforts shall fall within the scope of the embodiments. Accordingly, the following detailed description of embodiments provided in the accompanying drawings is not intended to limit the scope of the claimed embodiments, but merely represents selected embodiments. All other embodiments obtained by a person of ordinary skill in the art without any creative effort on the basis of the embodiments in the present disclosure shall fall into the scope of the present disclosure.

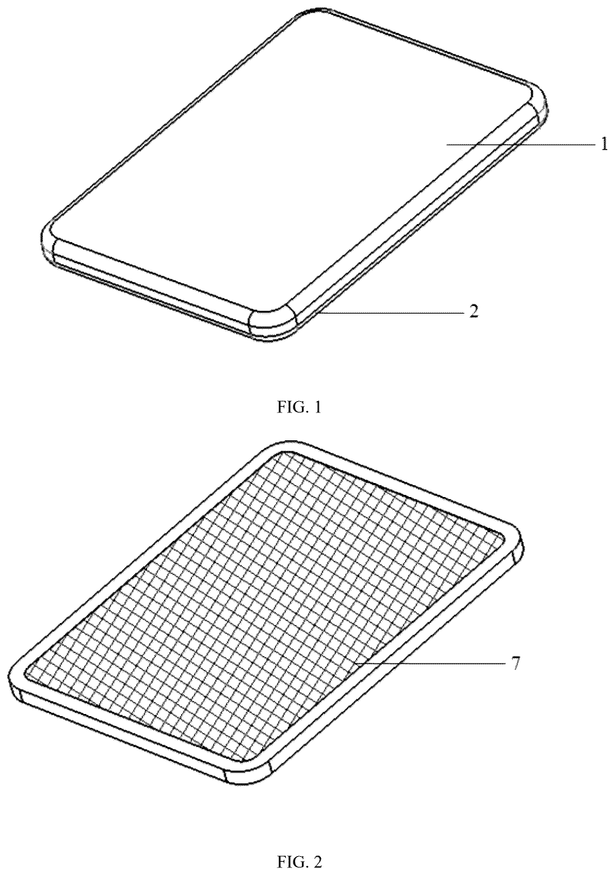

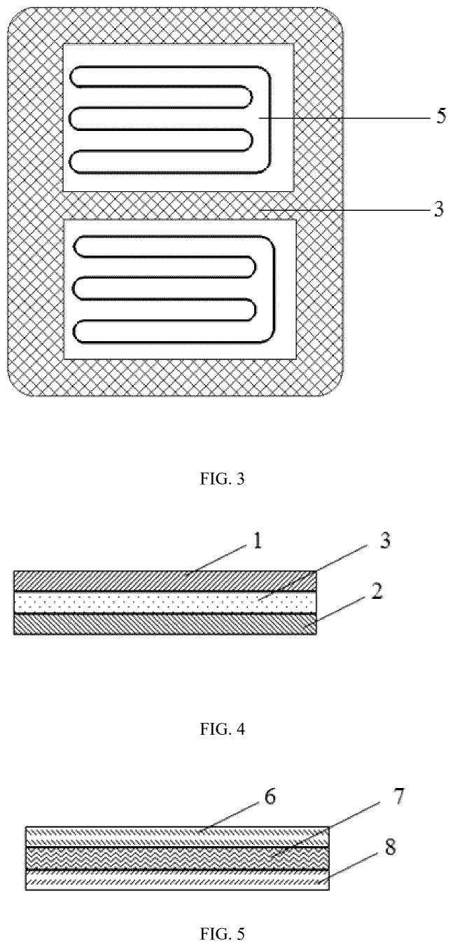

With reference to FIGS. 1 to 7, a heated quilt including a first warming layer 1, a second warming layer 2, and a heated layer 3 sandwiched between the first warming layer 1 and the second warming layer 2, the heated layer 3 being provided with a heating core 4 and a plug for connecting to a power source.

As the heated layer is provided between the two warming layers, a “sandwich structure” heated quilt is obtained, which utilizes the heated layer in the middle to generate heat, and the upper and lower warming layers in the structure of the quilt are able to provide good thermal insulation for the heat generated by the heated layer, so that the heat can form a ring-like heating environment inside the quilt, which makes the heating effect more durable and can provide users with a better heating effect. Due to the better heat preservation property, the heated quilt can achieve the expected warming effect at a lower heating temperature, which reduces the heating temperature and increases safety.

The heated layer 3 and the first warming layer 1 or the heated layer 3 and the second warming layer 2 are fixed by a number of fixing structures, and the fixing structures are evenly distributed throughout the heated layer 3 and the first warming layer 1 or throughout the heated layer 3 and the second warming layer 2. In the exemplary embodiment, the heated layer and the first warming layer or the heated layer and the second warming layer may be connected by punching points, or may be connected by any other means of connection available.

Fixing the heated layer evenly with one of the warming layers, which prevents the safety risk of the heating core inside the quilt due to folding, which further increases the safety compared to a conventional electric blanket. It also increases the fit between the heated layer and the first warming layer or the second warming layer, so that the separation between the heated layer 3 and the first warming layer 1 or the second warming layer 2 is not easy to occur, thus further increasing the comfort when using.

The first warming layer 1 and the second warming layer 2 in the heated quilt can also be set to be detachably connected, and even the heated layer 3 and the first warming layer 1 or the second warming layer 2 can also be set to be detachable, so that the thickness of the heated quilt can be adjusted according to the temperature or the season, or even the first warming layer 1 or the second warming layer 2 can be used alone, which enables the heated quilt not to be confined to the use of the winter with low temperature, increasing the practicality and flexibility of use.

The heating switch of the heated layer 3 is also wirelessly connected to the user's mobile terminal (wifi or Bluetooth, etc., any existing smart furniture remote control technology can be used), and the mobile terminal is capable of controlling the turning on or off of the heating switch. In addition to the traditional direct manual control of the heating, the user can turn on the heating in advance to increase the temperature of the quilt, which further increases the flexibility of use.

With reference to the accompanying FIG. 7, the heating core 4 of the heated layer 3 is threaded within the heating core pipe 5, the heating core pipe 5 preferably being provided as a double-layer structure or the heating core pipe being made of a single layer of ribbed fabric. the heating core pipe 5 may be made of a double-layer hydroentangled nonwoven fabric. The hydroentangled nonwoven fabric improves the softness of the heating core pipe and has a moisture and oil absorbing effect, which further improves the comfort of the heated quilt.

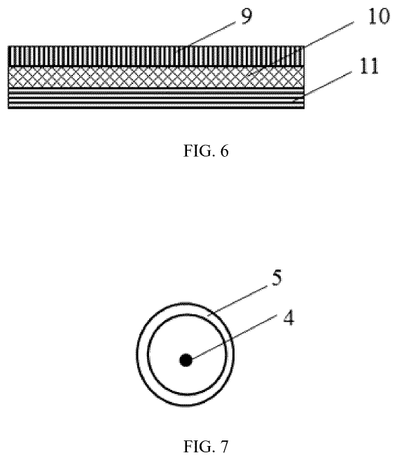

With reference to FIG. 5 to 6, the first warming layer 1 comprises, from top to bottom, a first face fabric layer 6, a first warming filler layer 7, and a first lining layer 8. Similarly, the second warming layer 2 includes, from top to bottom, a second face fabric layer 9, a second warming filler layer 10, and a second lining layer 11.

In exemplary embodiments, the amount of warmth filling in the first warmth filling layer 7 is greater than the amount of warmth filling in the second warmth filling layer 10. For example, the first warmth filler layer 7 may be filled with 150 g of polyester blend cotton, polyester cotton, or down, etc., and the second warmth filler layer 10 may be filled with 100 g of glue-free cotton or down, etc. The thickness of the first warmth filling layer is greater than the second warmth filling layer, so that the heated quilt forms a “thicker on top and thinner on the bottom” structure, and the first warmth layer with a larger thickness plays a major role in heat preservation, so that the heat will be transferred from the top to the bottom, to provide the user with a better effect of heat preservation.

In a more preferred embodiment, the heated layer can also be set up to independently heat the left and right zones, or the heated layer can be set up to independently heat the head and foot zones, or the four zones of the heated quilt of the left, right, head, and foot can be set up to be independently heated, which allows the user to select the zone to be heated when using the heated quilt, and also makes the heated quilt more energy efficient, and the use of higher flexibility.

In a more preferred embodiment, the heated quilt is provided with counterweights along its perimeter. In the exemplary construction, counterweight bags filled with counterweights may be sewn together around the perimeter of the heated quilt when sewing the first warmth layer and the second warmth layer together. Since the first warmth layer and the second warmth layer are turned to the front after being sewn together, the weighted bags are also located inside the heated quilt after being sewn together, for an overall more aesthetically pleasing appearance. Exemplarily, the weighted bags may be filled with sand, and the weight of the sand may be adjusted according to actual needs.

The setting of the counterweight around the heated quilt helps to increase the pressure borne by the body surface, relaxes the nervous system, acts as a stress reliever, and improves the quality of sleep. Compared to the gravity quilt in the prior art in which the counterweights are set along the entire backside, the manner in which the counterweights are set in the present embodiment simplifies the structure while realizing the corresponding function. In addition, the setting of the counterweight also prevents the heated quilt from leaking air, further ensures the heat preservation of the heated quilt, and the warmth preservation performance is superior to that of an ordinary quilt even when it is not heated.

What is claimed is:

1. A heated quilt, comprising:
a first warming layer, a second warming layer and a heated layer sandwiched between the first warming layer and the second warming layer, the heated layer being provided with a heating core;
the heated layer and the first warming layer or the heated layer and the second warming layer are secured by a number of fixing structures, the fixing structures being evenly distributed between the heated layer and the first warming layer or the heated layer and the second warming layer.

2. The heated quilt according to claim 1, wherein a heating switch of the heated layer is connected to a mobile terminal of a user, the mobile terminal being capable of controlling the opening or closing of the heating switch.

3. The heated quilt according to claim 1, wherein a heating core of the heated layer is threaded inside a heating core pipe.

4. The heated quilt according to claim 3, wherein the heating core pipe is a double-layer structure, or the heating core pipe is made of a single layer of ribbed fabric.

5. The heated quilt according to claim 4, wherein the heating core pipe is made of double layer hydroentangled non-woven fabric.

6. The heated quilt according to claim 1, wherein the first warming layer comprising, from top to bottom, a first face fabric layer, a first warmth-retaining material filling layer and a first lining fabric layer; and/or
the second warming layer comprising from top to bottom a second face fabric layer, a second warmth-retaining material filling layer and a second lining fabric layer.

7. The heated quilt according to claim 6, wherein the amount of warmth-retaining material of the first warmth filling layer is greater than the amount of warmth-retaining material of the second warmth-retaining material filling layer.

8. The heated quilt according to claim 7, wherein the first warmth-retaining material filling layer is filled with polyester blend cotton or polyester cotton, and the second warmth filler layer is filled with glue-free cotton.

9. The heated quilt according to claim 1, wherein the heated layer is set up to be heated independently in left and right zones, and/or the heated layer is set up to be independently heated in the head and foot zones.

10. The heating blanket according to claim 1, wherein the heated quilt is provided with counterweights along its perimeter.
